(19) United States
(12) Patent Application Publication
(10) Pub. No.: US 2023/0066915 A1
(43) Pub. Date: Mar. 2, 2023

(54) OBFUSCATION OF A SECTION OF AUDIO BASED ON CONTEXT OF THE AUDIO

(71) Applicant: Capital One Services, LLC, McLean, VA (US)

(72) Inventors: Yichen ZHANG, McLean, VA (US); Lin Ni Lisa CHENG, New York, NY (US); Tyler MAIMAN, Melville, NY (US); Tasneem ADAMJEE, McKinney, TX (US)

(21) Appl. No.: 17/446,379

(22) Filed: Aug. 30, 2021

(51) Int. Cl. G06F 21/62; G10L 17/04; G10L 17/24; G06F 21/31

(52) U.S. Cl. CPC G06F 21/6245; G10L 17/04; G10L 17/24; G06F 21/31

(57) ABSTRACT

In some implementations, a system may receive an audio stream associated with a call between a user and an agent. The system may analyze the audio stream to identify a trigger associated with the type of information. The system may monitor, based on identifying the trigger in a first section of the audio stream, a second section of the audio stream for audio content that identifies user information associated with the user. The system may identify a subsection of the second section that includes the audio content, wherein the subsection is identified based on a characteristic of the audio content and the type of information. The system may alter an audio characteristic of the subsection to prevent the agent from receiving the user information via the audio stream.

### BACKGROUND

An authentication process may be performed to verify an identity of an individual. For example, when the individual contacts a call center of an entity regarding an account maintained by the entity, the call center may authenticate the individual to verify that the user is associated with the account and not a fraudulent actor attempting to gain unlawful access to the account.

### SUMMARY

Some implementations described herein relate to a system for obfuscating audio that includes a type of information. The system may include one or more memories and one or more processors communicatively coupled to the one or more memories. The system may be configured to receive an audio stream associated with a call between a user and an agent associated with a call center. The system may be configured to process, using an audio obfuscation model, the audio stream to identify a trigger associated with the type of information. The system may be configured to monitor, based on identifying the trigger in a first section of the audio stream, a second section of the audio stream for audio content that identifies user information associated with the user. The system may be configured to detect the audio content based on a characteristic of the audio content and the type of information. The system may be configured to authenticate, based on obtaining the user information from the audio content, the user according to the user information. The system may be configured to obfuscate a subsection of the second section that includes the audio content to prevent the agent from receiving the user information via the audio stream. The system may be configured to facilitate, based on authenticating the user, the call between the user and the agent.

Some implementations described herein relate to a non-transitory computer-readable medium that stores a set of instructions for a system. The set of instructions, when executed by one or more processors of the system, may cause the system to monitor an audio stream associated with a call between a user and an agent. The set of instructions, when executed by one or more processors of the system, may cause the system to process, using an audio obfuscation model, the audio stream to identify a trigger associated with a type of information that is to be obfuscated. The set of instructions, when executed by one or more processors of the system, may cause the system to monitor, based on identifying the trigger in a first section of the audio stream, a second section of the audio stream for audio content that identifies user information associated with the user. The set of instructions, when executed by one or more processors of the system, may cause the system to detect the audio content based on a characteristic of the audio content and the type of information. The set of instructions, when executed by one or more processors of the system, may cause the system to obfuscate a subsection of the second section that includes the audio content to prevent the agent from receiving the user information via the audio stream.

Some implementations described herein relate to a method for obfuscating a section of an audio signal that includes a type of information. The method may include receiving, by a device, an audio stream associated with a call between a user and an agent. The method may include analyzing the audio stream to identify a trigger associated with the type of information. The method may include monitoring, based on identifying the trigger in a first section of the audio stream, a second section of the audio stream for audio content that identifies user information associated with the user. The method may include identifying, by the device, a subsection of the second section that includes the audio content, where the subsection is identified based on a characteristic of the audio content and the type of information. The method may include altering, by the device, an audio characteristic of the subsection to prevent the agent from receiving the user information via the audio stream.

### BRIEF DESCRIPTION OF THE DRAWINGS

FIGS. 1A-1C are diagrams of an example implementation associated with obfuscating a section of audio based on context of the audio.

FIG. 2 is a diagram of an example environment in which systems and/or methods described herein may be implemented.

FIG. 3 is a diagram of example components of one or more devices of FIG. 2.

FIG. 4 is a flowchart of an example process associated with obfuscating a section of audio based on context of the audio.

### DETAILED DESCRIPTION

The following detailed description of example implementations refers to the accompanying drawings. The same reference numbers in different drawings may identify the same or similar elements.

In some instances, when a user contacts an agent (e.g., a customer service representative) of an entity regarding an account maintained by the entity (e.g., a member account, a financial account, and/or the like), the agent authenticates the user to verify that the user is associated with the account and not a fraudulent actor attempting to gain unlawful access to the account. In such cases, to authenticate the user, the service representative may ask the user to verify authentication information. The authentication information may be sensitive information, such as confidential information (e.g., a name, a date of birth, and/or a social security number), personal information associated with the account that was previously provided to the entity (e.g., answers to personal questions that are asked for security purposes), account information associated with the account (e.g., an account number of the account), or other non- public information. In such cases, if the user provides authentication information that matches the authentication information of the account, the agent may authenticate the user and enable the user to access other information associated with the account and/or perform an action associated with the account. However, such an authentication process exposes the sensitive information of the user to the agent. Accordingly, if the agent has malicious intentions, the agent may acquire the sensitive information and/or the account information for fraudulent use (e.g., to gain unauthorized access to the user's account).

While a call center system can mute an agent's audio for a time period after a user is prompted to speak or share authentication information, in such cases, the time period is generally a fixed time period and/or the user is requested to indicate when such authentication information has been provided. Accordingly, if the user does not understand instructions in the prompt and/or mishears instructions for providing the authentication information, the agent may be unable to assist the user (e.g., because the agent's audio is muted) and/or the user may provide the authentication information to the agent (e.g., outside of the time period or after indicating that the authentication information has been provided). Moreover, the user may still provide user information (e.g., authentication information or other sensitive information) to the agent without being prompted (e.g., under the assumption that the agent may need the authentication information because the user is accustomed to agents traditionally requesting such information). Accordingly, there is a need for a system that can protect a user's sensitive information without disrupting a conversation between the agent and the user, to both protect the user's sensitive information and enable the agent and the user to effectively communicate if the user requires assistance.

Some implementations described herein provide a call management system that facilitates an ongoing communication session between a user and an agent while authenticating the user via spoken user information from the user without the agent receiving (or hearing) the user information. For example, as described herein, the call management system may monitor audio on the call, detect from context or other information on the call that the user is about to speak or share user information (e.g., sensitive information associated with the user or other types of information associated with the user) with the agent, and obfuscate a portion of the audio that includes the user information. In some implementations, only the portion of the audio that includes the user information is obfuscated. More specifically, the call management system, as described herein, may include a machine learning model that is trained to identify or detect only portions of audio that include certain characteristics of audio content of a call that is associated with a particular type of sensitive information. The call management system may obfuscate the audio in real-time (or near real-time) such that the agent and/or the user are able to communicate with one another, without sharing certain types of user information during the call.

In this way, the call management system, as described herein, may facilitate a call between a user and an agent while protecting sensitive information associated with the user and enabling relatively continued communication between the agent and the user. Accordingly, the call management system may prevent fraudulent activity involving a user's account that may result from a malicious agent obtaining sensitive information from the user while the user is communicating with the agent. Moreover, the call management system may improve a user experience associated with an authentication process (e.g., relative to using automated systems or encountering problems during an authentication process).

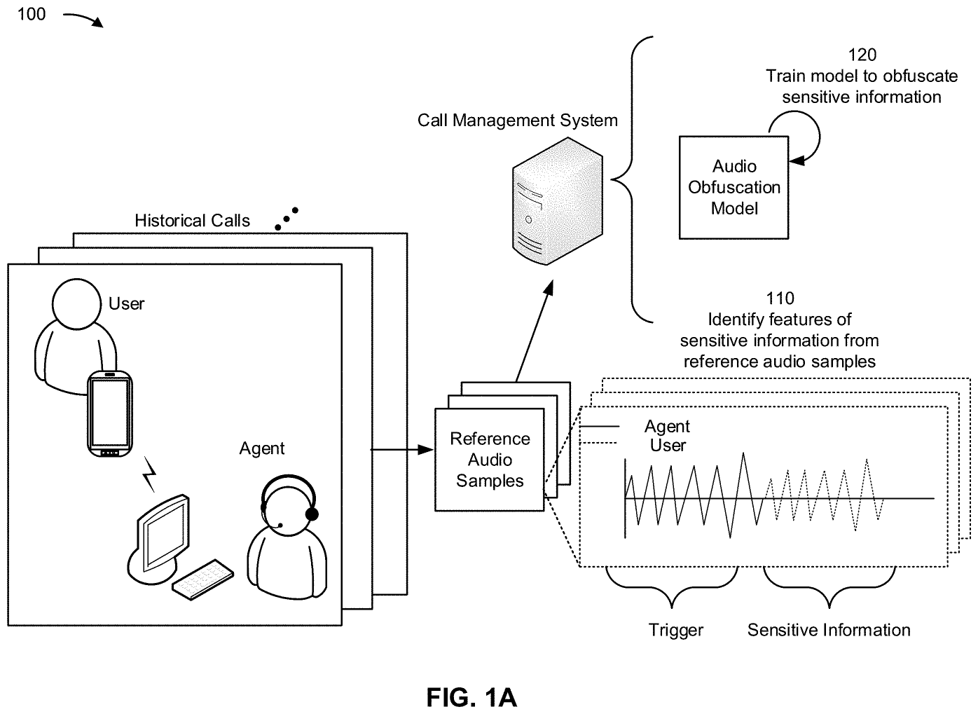

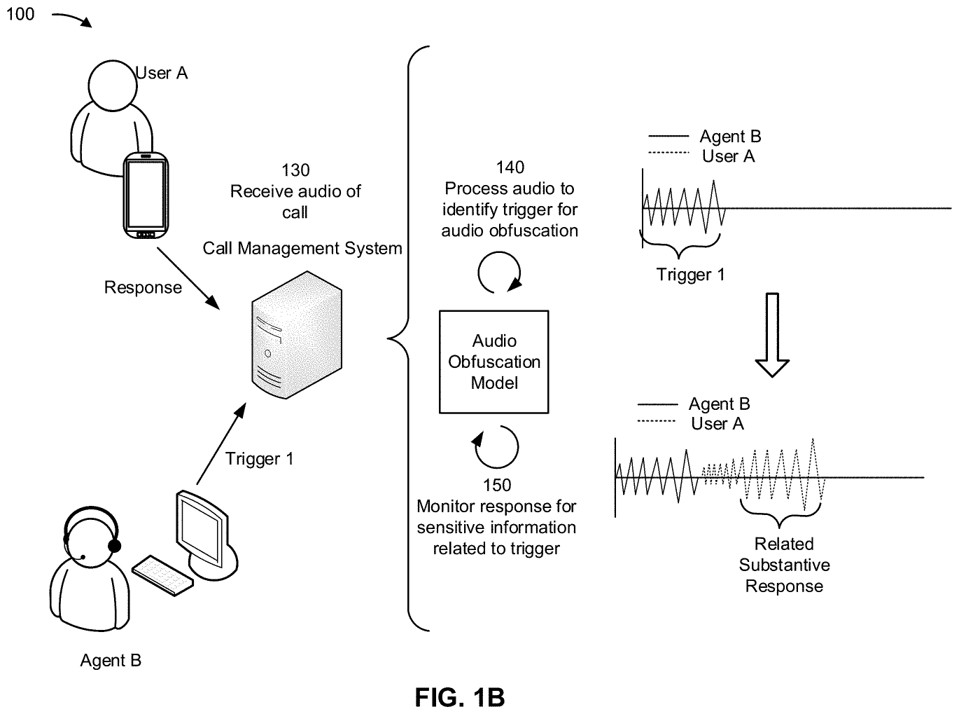

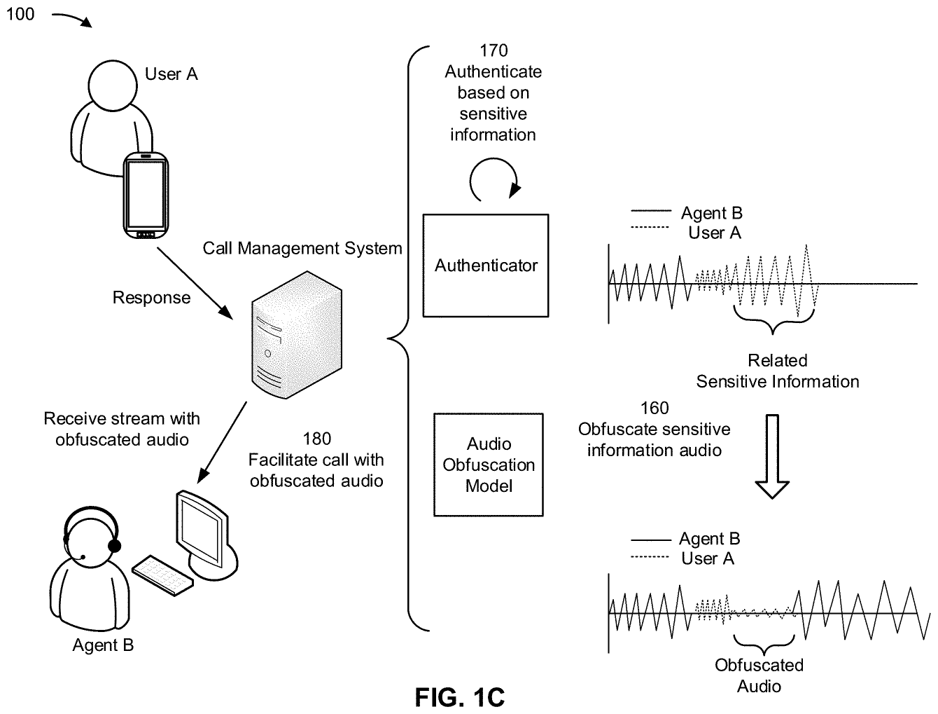

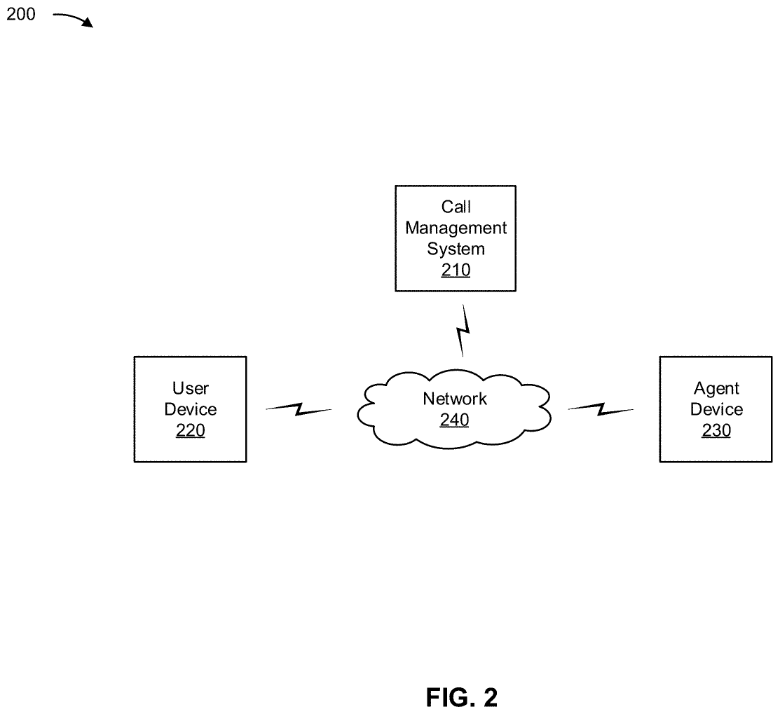

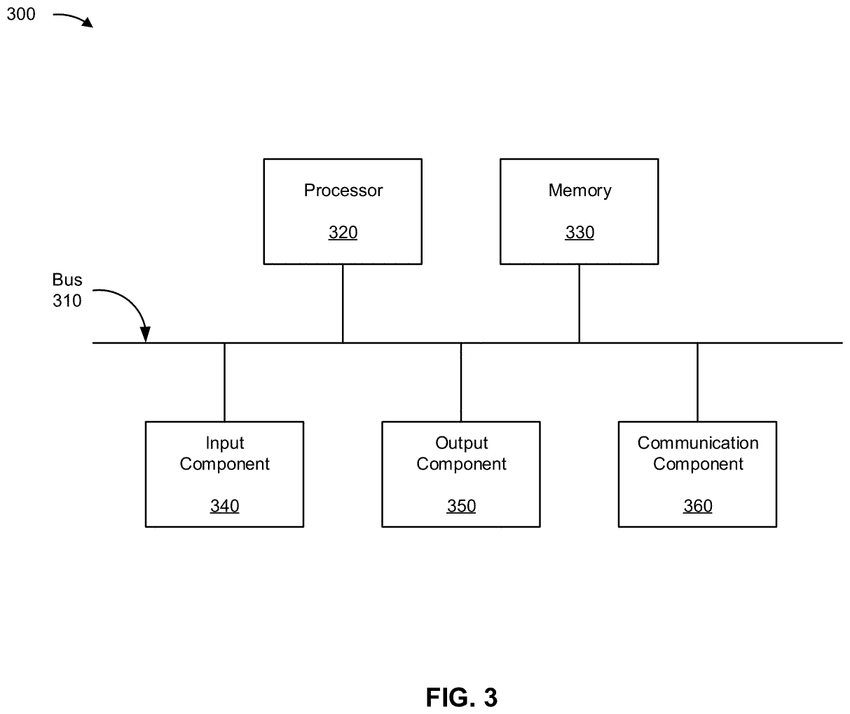

FIGS. 1A-1C are diagrams of an example implementation 100 associated with obfuscating a section of an audio signal that includes a type of content. Example implementation 100 includes a call management system, a user device, and an agent device. These devices are further described below, in connection with FIG. 2 and FIG. 3.

The call management system of example implementation 100 may be associated with a call center that is associated with (e.g., owned and/or operated by) an entity (e.g., a service provider or organization that provides customer service via the call center). As shown, the call management system may include an audio obfuscation model that is configured to obfuscate audio content, as described herein, and an authenticator to authenticate a user based on user information in audio that is obfuscated by the audio obfuscation model.

As shown in FIG. 1A, and by reference number 110, the call management system identifies features of sensitive information from reference audio samples. For example, as shown, the call management system may be configured to analyze (e.g., using one or more speech processing techniques, such as a natural language processing technique, a voice recognition technique, a sentiment analysis technique, or the like) reference audio samples to identify a section of audio that includes a trigger and a section of audio that includes sensitive information. As shown, the reference audio samples may be historical calls between users and agents (e.g., historical calls that are recorded by a call center for customer services purposes). In some implementations, the reference audio samples may be specifically associated with a particular type of sensitive information or set of sensitive information. Correspondingly, the identified triggers may be specifically associated with the particular type of sensitive information or set of sensitive information and/or provide context for a subsequent utterance of the particular type of sensitive information or set of sensitive information.

As a specific example, for sensitive information that includes an account number, the audio obfuscation model may identify spoken triggers in audio content are related to or mention an account number. Although FIG. 1A shows the trigger being spoken by the agent, the trigger may be spoken by the user. For example, a trigger to cause the call management system (e.g., via the audio obfuscation model) to monitor for an account number may include an agent speaking “please provide your account number” or “can you provide your account number.” Additionally, or alternatively, a trigger associated with an account number may include a user speaking “my account number is” or “let me give you my account number.” Correspondingly, the call management system may be configured to identify audio that includes the account number and/or a type or format of the account number. For example, the call management system and/or the audio obfuscation model may be configured to identify trends or patterns of audio associated with the type or format of account numbers for user accounts of an entity that is associated with the call management system. More specifically, the call management system may be configured to identify that account numbers are a series of numbers, a series of letters, a series of numbers and/or letters, letters and/or numbers in a particular arrangement or format (e.g., which may be defined by dashes, periods, commas, or other punctuation), a series of numbers or letters that start with, end with, or include a specific series of numbers or letters, and so on.

In some implementations, the audio obfuscation model may identify which party spoke the trigger and/or which party spoke the account information (e.g., based on whether the trigger or account information was received through a user audio input or an agent audio input). In this way, the audio obfuscation model may learn certain triggers that are typically spoken by agents and certain triggers that are typically spoken by users. Additionally, or alternatively, a feature of the reference audio samples may include time information associated with the trigger being spoken and/or the account information being spoken. For example, the time information may indicate a time during a call that the trigger is spoken that is relative to a duration of the call (or a start of the call) and time information for sensitive information may indicate a time relative to the trigger being spoken during the call.

In some implementations, the features from the reference audio samples may be obtained according to a supervised learning technique. For example, a trigger and sensitive information can be marked (e.g., using timestamps for the trigger and timestamps for the sensitive information) in a reference audio sample. In this way, using the supervised learning technique, the audio obfuscation model may extract the trigger and the sensitive information from the audio to permit the call management system (or other system) to train the audio obfuscation model according to sections of audio that include the triggers and sections of audio that include the sensitive information. Additionally, or alternatively, the audio obfuscation model may utilize an unsupervised learning technique (e.g., using a clustering technique, natural language processing, and/or the like).

In this way, the audio obfuscation model may be configured to identify a trigger and/or corresponding sensitive information associated with the trigger. The audio obfuscation model may be configured to identify triggers for multiple different types of sensitive information. Additionally, or alternatively, the audio obfuscation model may be configured to identify a single trigger for a single type of sensitive information. In some implementations, the call management system may include multiple models that are configured to identify individual sets of triggers associated with respective types of sensitive information. For example, a first audio obfuscation model may be configured to monitor for and obfuscate account numbers associated with user accounts of users, and a second audio obfuscation model may be configured to monitor for and obfuscate dates of birth of the users.

As further shown in FIG. 1A, and by reference number 120, the call management system trains the audio obfuscation model to obfuscate responses with sensitive information. For example, the call management system may train the audio obfuscation model according to the identified features of the triggers, the sensitive information, or the like. The call management system may train the audio obfuscation model according to any suitable technique, such as a random-forest technique, a clustering technique, a neural network technique, a deep learning technique, or any other artificial intelligence training technique.

In this way, the audio obfuscation model may be trained based on reference audio data and/or reference trigger data (e.g., data that is representative of learned or identified triggers associated with one or more types of sensitive information) associated with previous triggers spoken during historical calls associated with the call center. The historical calls may be associated with a particular agent. In such a case, the call management system may train the audio obfuscation model specifically for calls involving the particular agent. Additionally, or alternatively, the historical calls may be associated with multiple agents. In such a case, the call management system may train the audio obfuscation model for various agents associated with the call center.

As shown in FIG. 1B, and by reference number 130, the call management system receives audio of a call. For example, the call management system may receive an audio stream that is associated with a call between a user (User A) and an agent (Agent B) associated with the call center. The call management system may receive the audio stream based on being configured to host and/or facilitate the call between the user and the agent. The audio stream may be communicated between a user device associated with the user and an agent device associated with the agent. Accordingly, the call management system may receive audio of the call from the user and/or the agent to monitor an audio stream associated with the call, as described herein.

In some implementations, the user initiates the call with the call management system. For example, the user may contact (e.g., via a voice call from the user device) the call management system and/or the agent to discuss a matter associated with an account of the user. More specifically, the user may contact the call management system and/or the agent to receive a service from an entity associated with the call center and/or discuss a service of the entity. In some implementations, the call management system and/or agent may initiate the call with the user. For example, the call management system and/or the agent may contact the user to verify information associated with the user account, to verify a transaction involving the user account, to provide information associated with the use account, or to offer a service associated with the user account.

The audio stream may include a user-side channel that is between the user device and the call management system and an agent-side channel that is between the call management system and the agent device. The user-side channel may include a user audio input (audio input from the user device to the call management system) and a user audio output (an output from the call management system to the user device). Similarly, the agent-side channel may include an agent audio input (audio input from the agent device to the call management system) and an agent audio output (an output from the call management system to the agent device). As shown, the received audio may include a trigger (Trigger 1) received on the agent audio input and a response received from the user. As describe elsewhere herein, the response may include user information (e.g., sensitive information or non-public information) associated with the user. In some implementations, the call management system may receive audio content that includes a trigger (e.g., a trigger associated with a same type of sensitive information as Trigger 1) from the user device (e.g., via the user audio input).

As further shown in FIG. 1B, and by reference number 140, the call management system processes the audio to identify a trigger for audio obfuscation. For example, the call management system may analyze the audio stream to identify a trigger associated with a particular type of information (e.g., sensitive information associated with the user). The call management system, to analyze the audio, may cause the audio obfuscation model to process the audio stream according to the type of information (e.g., to identify a trigger associated with a particular type of information or a particular type of sensitive information).

In some implementations, the call management system may be configured to process a particular channel of the audio stream and/or input of the audio stream in order to identify a trigger associated with sensitive information. For example, the call management system may cause the audio obfuscation model to analyze an agent audio input of a section (e.g., a first section) of the audio stream to identify the trigger because the agent may be expected to prompt or request the user to provide the sensitive information (e.g., as learned and/or identified during training of the audio obfuscation model). The section of the audio stream may be a particular portion of the audio stream that is learned or identified by the call management system based on training the audio obfuscation model (e.g., because a timing feature associated with a trigger indicates that the trigger is typically spoken during a particular time period associated with the section of the audio stream). In this way, the audio obfuscation model may conserve resources by only monitoring a single audio input associated with the call (or audio stream).

In this way, the call management system, using an audio obfuscation model, may process the audio stream to identify a trigger associated with a type of information that is to be obfuscated.

As further shown in FIG. 1B, and by reference number 150, the call management system monitors a response for sensitive information that is related to the trigger. For example, the call management system may monitor a subsequent section (e.g., a second section) of the audio stream for audio content that identifies user information associated with the user. As described herein, the user information may be sensitive information or non-public information that is to be withheld from the agent to prevent fraud and/or to maintain security of the user information.

In some implementations, to monitor for the sensitive information, the call management system may cause the audio obfuscation model to monitor the user audio input of the audio stream for audio content that includes the sensitive information. The audio obfuscation model, based on being trained according to the reference audio samples and/or identified features of uttered sensitive information, may monitor the audio stream for content that specifically indicates or is associated with a format of the user information that is to be protected. For example, the audio obfuscation model may be configured to detect the audio content based on a characteristic of the audio content and the type of information. The characteristic of the audio content may include a particular type of content spoken within the audio content that is associated with the type of information, a value spoken within the audio content that is associated with the type of information, and/or a word (or phrase) spoken within the audio content that is associated with the type of information. More specifically, if the type of information is an address of the user (e.g., the trigger indicates that the user is to provide the user's address), the type of content may include speech with words in an address format (e.g., words for street numbers, followed by words for a street, followed by word(s) of a city, followed by word(s) of a state, followed by words for numbers of a zip code, and so on). As another example, if the type of information is a social security number, the audio obfuscation model may monitor for numbers in a particular format (e.g., a series of nine numbers, numbers uttered in XXX-XX-XXXX format or sequence, and so on).

As shown in FIG. 1C, and by reference number 160, the call management system obfuscates the sensitive information audio. For example, the call management system, via the audio obfuscation model, may obfuscate a subsection of the section of the audio stream (e.g., the second section) that includes the audio content to prevent the agent from receiving the user information via the audio stream. The call management system may obfuscate the audio content by altering an audio characteristic of the subsection to prevent the agent from receiving the sensitive information via the audio stream. More specifically, the call management system (and/or the audio obfuscation model) may alter an audio frequency or an audio amplitude associated with the subsection of the response that includes the sensitive information.

The call management system may obfuscate only the section of the audio that includes the characteristic of the sensitive information that the audio obfuscation model is trained to detect. In this way, obfuscating only those portions of the audio in the response that include the sensitive information can permit the user to continue to communicate with the agent before providing the sensitive information, between providing portions of the sensitive information, or after providing the sensitive information. In this way, the user may ask the agent for assistance and/or request the agent to reinstruct the user on what information is to be provided because the agent is not prevented from receiving portions of the response that do not include the sensitive information.

As further shown in FIG. 1C, and by reference number 170, the call management system may authenticate the user based on the sensitive information. As shown, a portion of the response from User A may include the sensitive information associated with the trigger. The authenticator, based on the receiving the type of information associated with the trigger and the audio content that includes the sensitive information, may perform an authentication process to authenticate the user, using any suitable technique. For example, the authenticator may verify that the sensitive information that was spoken by the user matches sensitive information stored in a data structure associated with the user account that is configured for authenticating the user. For example, the authenticator may lookup the sensitive information in the data structure to confirm that the user accurately provided the sensitive information.

Accordingly, the call management system, based on obtaining (or extracting) user information from the audio content, may authenticate the user according to the user information. In this way, in order to authorize the call between the user and the agent, the user may be authenticated based on the authentication process verifying that the user information is associated with the user.

In some implementations, the call management system (and/or the authenticator) may provide an indication to the agent device to indicate whether the user has been authenticated. For example, the call management system may transmit an authentication message indicating that the user has been authenticated for the call to indicate that the agent is able to provide a service for the user and/or assist the user over the call.

As further shown in FIG. 1C, and by reference number 180, the call management system facilitates the call with the obfuscated audio. For example, the call management system may provide the response with the subsection of the audio that includes the user information being obfuscated. Except for the subsection of the user audio input that includes audio content with the sensitive information, the call management system may forward all remaining portions of the user audio input onto the agent audio output (without obfuscating the remaining portions of the user audio input until a subsequent section with sensitive information is detected).

Accordingly, as described herein, the agent may receive any communications from the user other than specific sections of audio that include sensitive information associated with the user (or other types of user information). Accordingly, the call management system may reduce or prevent fraud associated with an agent obtaining sensitive information associated with a user, and improve a user experience associated with an authentication process by enabling continuous communication with the agent that permits the agent to assist the user during the authentication process. Furthermore, as described herein, the call management system may prevent a user from unilaterally providing sensitive information (e.g., even when not prompted by the agent) by obfuscating audio that includes the sensitive information. Accordingly, the call management system may reduce or prevent unnecessary exposure of a user's sensitive information.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a call management system 210, a user device 220, an agent device 230, and a network 240. Devices of environment 200 may interconnect via wired connections, wireless connections, or a combination of wired and wireless connections.

The call management system 210 includes one or more devices capable of receiving, generating, storing, processing, providing, and/or routing information for a call in association with obfuscating a section of audio of the call based on context of the audio, as described elsewhere herein. The call management system 210 may include a communication device and/or a computing device. For example, the call management system 210 may include a server, such as an application server, a client server, a web server, a database server, a host server, a proxy server, a virtual server (e.g., executing on computing hardware), or a server in a cloud computing system. In some implementations, the call management system 210 includes computing hardware used in a cloud computing environment.

The user device 220 includes one or more devices capable of receiving, generating, storing, processing, and/or providing information associated with a call with the agent device 230 and that is managed by the call management system 210, as described elsewhere herein. The user device may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 220 may be associated with a user, as described elsewhere herein.

The agent device 230 includes one or more devices capable of receiving, generating, storing, processing, and/or providing information associated with a call with the user device 220 and that is managed by the call management system 210, as described elsewhere herein. The agent device 230 may include a communication device and/or a computing device. For example, the agent device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The agent device 230 may be associated with an agent, a call center, and/or an entity that provides a customer service, as described elsewhere herein.

The network 240 includes one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

[symbol]

FIG. 3 is a diagram of example components of a device 300, which may correspond to the call management system 210, the user device 220, and/or the agent device 230. In some implementations, the call management system 210, the user device 220, and/or the agent device 230 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

[symbol]

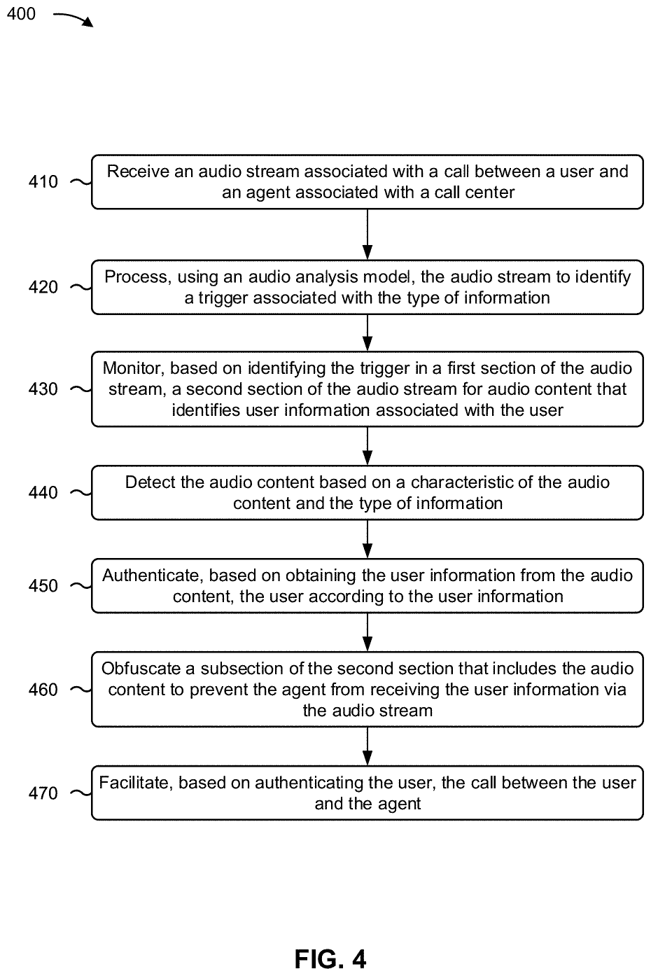

FIG. 4 is a flowchart of an example process 400 associated with obfuscating a section of audio based on context of the audio. In some implementations, one or more process blocks of FIG. 4 may be performed by a call management system (e.g., call management system 210). In some implementations, one or more process blocks of FIG. 4 may be performed by another device or a group of devices separate from or including the call management system, such as the user device 220 and/or the agent device 230. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving an audio stream associated with a call between a user and an agent associated with a call center (block 410). As further shown in FIG. 4, process 400 may include processing, using an audio obfuscation model, the audio stream to identify a trigger associated with the type of information (block 420). The audio obfuscation model may be trained based on reference audio data and reference trigger data associated with previous triggers spoken during historical calls associated with the call center.

As further shown in FIG. 4, process 400 may include monitoring, based on identifying the trigger in a first section of the audio stream, a second section of the audio stream for audio content that identifies user information associated with the user (block 430). As further shown in FIG. 4, process 400 may include detecting the audio content based on a characteristic of the audio content and the type of information (block 440).

As further shown in FIG. 4, process 400 may include authenticating, based on obtaining the user information from the audio content, the user according to the user information (block 450). As further shown in FIG. 4, process 400 may include obfuscating a subsection of the second section that includes the audio content to prevent the agent from receiving the user information via the audio stream (block 460). As further shown in FIG. 4, process 400 may include facilitating, based on authenticating the user, the call between the user and the agent (block 470).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for obfuscating audio that includes a type of information, the system comprising:
one or more memories; and
one or more processors, communicatively coupled to the one or more memories, configured to:
receive an audio stream associated with a call between a user and an agent associated with a call center;
process, using an audio obfuscation model, the audio stream to identify a trigger associated with the type of information,
wherein the audio obfuscation model is trained based on reference audio data and reference trigger data associated with previous triggers spoken during historical calls associated with the call center;
monitor, based on identifying the trigger in a first section of the audio stream, a second section of the audio stream for audio content that identifies user information associated with the user;
detect the audio content based on a characteristic of the audio content and the type of information;
authenticate, based on obtaining the user information from the audio content, the user according to the user information;
obfuscate a subsection of the second section that includes the audio content to prevent the agent from receiving the user information via the audio stream; and
facilitate, based on authenticating the user, the call between the user and the agent.

2. The system of claim 1, wherein the audio stream comprises:
a user audio input that is received from a user device associated with the user; and
an agent audio input that is received from an agent device associated with the agent.

3. The system of claim 2, wherein the one or more processors, to process the audio stream to identify the trigger, are configured to:
cause the audio obfuscation model to analyze an agent audio input of the first section of the audio stream to identify the trigger,
wherein the agent audio input is received from the agent device.

4. The system of claim 2, wherein the one or more processors, to monitor the second section of the audio stream for the audio content, are configured to:
monitor a user audio input of the second section of the audio stream for the audio content,
wherein the user audio input is received from the user device.

5. The system of claim 1, wherein the characteristic of the audio content comprises:
a particular type of content spoken within the audio content that is associated with the type of information,
a value spoken within the audio content that is associated with the type of information, or
a word spoken within the audio content that is associated with the type of information.

6. The system of claim 1, wherein the one or more processors, to authenticate the user, are configured to:
perform, based on the audio content, an authentication process based on the user information,
wherein the user is authenticated based on the authentication process verifying that the user information is associated with the user.

7. The system of claim 6, wherein the one or more processors are further configured to:
provide, to an agent device associated with the agent and based on a result of the authentication process, an indication that the user has been authenticated according to the user information.

8. A non-transitory computer-readable medium storing a set of instructions, the set of instructions comprising:
one or more instructions that, when executed by one or more processors of a system, cause the system to:
monitor an audio stream associated with a call between a user and an agent;
process, using an audio obfuscation model, the audio stream to identify a trigger associated with a type of information that is to be obfuscated;
monitor, based on identifying the trigger in a first section of the audio stream, a second section of the audio stream for audio content that identifies user information associated with the user;
detect the audio content based on a characteristic of the audio content and the type of information; and
obfuscate a subsection of the second section that includes the audio content to prevent the agent from receiving the user information via the audio stream.

9. The non-transitory computer-readable medium of claim 8, wherein the one or more instructions, that cause the system to process the first section of the audio stream to identify the trigger, cause the system to:
cause the audio obfuscation model to analyze an agent audio input of the first section of the audio stream,
wherein the agent audio input is received from an agent device associated with the agent.

10. The non-transitory computer-readable medium of claim 8, wherein the one or more instructions, that cause the system to monitor the audio stream, cause the system to:
monitor a user audio input of the second section of the audio stream,
wherein the user audio input is received from a user device associated with the user.

11. The non-transitory computer-readable medium of claim 8, wherein the characteristic of the audio content comprises:
a particular type of content spoken within the audio content that is associated with the type of information,
a value spoken within the audio content that is associated with the type of information, or
a word spoken within the audio content that is associated with the type of information.

12. The non-transitory computer-readable medium of claim 8, wherein the one or more instructions that cause the system to obfuscate the subsection of the second section cause the system to:
alter an audio frequency or an audio amplitude of the subsection of the second section.

13. The non-transitory computer-readable medium of claim 8, wherein the one or more instructions further cause the system to:
perform, based on the audio content, an authentication process to authenticate the user, according to the user information, in order to authorize the call between the user and the agent without the agent receiving the user information.

14. The non-transitory computer-readable medium of claim 8, wherein the audio obfuscation model is trained based on reference audio data and reference trigger data associated with previous triggers spoken during historical calls associated with the agent or another agent.

15. A method for obfuscating a section of an audio signal that includes a type of information, comprising:
receiving, by a device, an audio stream associated with a call between a user and an agent;
analyzing the audio stream to identify a trigger associated with the type of information;
monitoring, based on identifying the trigger in a first section of the audio stream, a second section of the audio stream for audio content that identifies user information associated with the user;
identifying, by the device, a subsection of the second section that includes the audio content,
wherein the subsection is identified based on a characteristic of the audio content and the type of information; and
altering, by the device, an audio characteristic of the subsection to prevent the agent from receiving the user information via the audio stream.

16. The method of claim 15, wherein the audio stream is communicated between a user device associated with the user and an agent device associated with the agent.

17. The method of claim 15, wherein analyzing the audio stream to identify the trigger comprises:
causing an audio obfuscation model to process the audio stream according to the type of information,
wherein the audio obfuscation model is trained based on reference audio data and reference trigger data associated with previous triggers spoken during historical calls associated with a call center.

18. The method of claim 15, wherein monitoring the audio stream comprises:
monitoring a user audio input of the second section of the audio stream,
wherein the user audio input is received from a user device associated with the user.

19. The method of claim 15, further comprising:
performing, based on the audio content, an authentication process to authenticate the user, according to the user information, in order to authorize the call between the user and the agent without the agent receiving the user information.

20. The method of claim 15, further comprising:
performing, based on the audio content, an authentication process to authenticate the user according to the user information; and
providing, to an agent device associated with the agent and based on a result of the authentication process, an indication of whether the user has been authenticated according to the authentication process.
